(19) United States
(12) Patent Application Publication
(10) Pub. No.: US 2025/0340457 A1
(43) Pub. Date: Nov. 6, 2025

(54) SYSTEMS AND METHODS FOR EXTRACTION OF FLUORINATED HYDROCARBONS

(71) Applicant: Khalifa University of Science and Technology, Abu Dhabi (AE)

(72) Inventors: Sana EID, Abu Dhabi (AE); Enas NASHEF, Abu Dhabi (AE); Fawzi BANAT, Abu Dhabi (AE); Shadi HASAN, Abu Dhabi (AE); Ahmad DARWISH, Abu Dhabi (AE); Tarek LEMAOUI, Abu Dhabi (AE)

(21) Appl. No.: 18/652,077

(22) Filed: May 1, 2024

(51) Int. Cl. C02F 1/26; B01D 11/04; C02F 101/36

(52) U.S. Cl. CPC C02F 1/26; B01D 11/0492; C02F 2101/36

(57) ABSTRACT

A method for liquid-liquid extraction includes contacting a first liquid with a second liquid sufficient to extract one or more per- and polyfluoroalkyl substances (PFASs) from the first liquid, wherein the second liquid includes a deep eutectic solvent.

### TECHNICAL FIELD

The subject matter disclosed herein relates to separations and purification and, in particular, to liquid-liquid extraction.

### BACKGROUND

In recent years, the increasing release of poly- and perfluoroalkyl substances (PFASs) into the environment (such as in water) has led to environmental concerns. PFASs are released into the environment through point sources, including industrial effluents and wastewater treatment plants (WWTPs), and nonpoint sources that are not traceable to a single, identifiable point of discharge. These substances are hazardous, tend to accumulate in living organisms, and exhibit resistance to environmental degradation. PFASs are a diverse group of synthetic fluorinated organic compounds characterized by a hydrophobic carbon chain that is fully or partially saturated with fluorine atoms and forms strong carbon-fluorine (C—F) bonds. These robust bonds are responsible for the remarkable persistence in the environment, which has led to PFASs being commonly referred to as ‘eternal chemicals’. PFASs exhibit high mobility in the environment and tend to accumulate in organisms, including humans. Accordingly, adsorption and membrane systems have been developed to remove PFASs from water. These systems suffer from low removal efficiencies, poor selectivity, and high energy requirements. For example, membranes require high-pressure filtration or osmotic processes, and these membrane systems are susceptible to fouling.

### SUMMARY

According to one aspect, a method for liquid-liquid extraction includes contacting a first liquid with a second liquid sufficient to extract one or more per- and polyfluoroalkyl substances (PFASs) from the first liquid, wherein the second liquid includes a deep eutectic solvent.

According to another aspect, a method for liquid-liquid extraction includes introducing a first liquid into a liquid-liquid extraction unit, wherein the first liquid includes water and one or more per- and polyfluoroalkyl substances (PFASs); and introducing a second liquid into the liquid-liquid extraction unit, wherein the second liquid includes a hydrophobic deep eutectic solvent having a viscosity less than 120 mPas at 25° C.

According to another aspect, a deep eutectic solvent composition includes a liquid mixture including a first component and a second component, wherein the first component includes trioctylphosphine oxide (TOPO), and wherein the second component includes at least one of lauric acid and decanoic acid, wherein the liquid mixture has a viscosity less than about 120 mPas at 25° C.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates method 100 for liquid-liquid extraction, according to some embodiments.

FIG. 2 illustrates method 200 for liquid-liquid extraction, according to some embodiments.

FIG. 3 illustrates extraction system 300, according to some embodiments.

FIG. 4 illustrates an example method of extraction, according to some embodiments.

FIG. 5 illustrates extraction efficiency, density, and viscosity of various extraction solvents, according to some embodiments.

FIG. 6A illustrates density, viscosity, and predicted values with temperature for TOPO: LauA (1:1), according to some embodiments.

FIG. 6B illustrates thermogravimetric profiles of TOPO, LauA, and TOPO: LauA (1:1), according to some embodiments.

FIG. 7A illustrates the influence of pH and solvent: feed ratio on TOPO: LauA-PFOA extraction performance, according to some embodiments.

FIG. 7B illustrates the influence of mixing time and temperature on TOPO: LauA-PFOA extraction performance, according to some embodiments.

FIG. 7C illustrates the influence of initial feed concentration on TOPO: LauA-PFOA extraction, according to some embodiments.

FIG. 8A illustrates multi-cycle performance of TOPO: LauA over seven consecutive cycles using fresh 1000 mg/L PFOA feed solution in each cycle, according to some embodiments.

FIG. 8B illustrates FT-IR spectra of fresh TOPO: LauA and TOPO: LauA after the first and seventh cycles, according to some embodiments.

FIG. 8C illustrates FT-IR spectra of 1000 mg/L PFOA feed water, and water after the first and seventh cycles, according to some embodiments.

FIG. 9A illustrates extraction efficiencies of PFHA and PFOA in single-solute solutions at 1000 ppm and in mixtures at 500 ppm and 1 ppm, according to some embodiments.

FIG. 9B illustrates extraction efficiency of TOPO: LauA in DI water compared to that in synthetic wastewater, according to some embodiments.

### DETAILED DESCRIPTION

The present disclosure provides solvents, extraction methods, and liquid-liquid extraction systems for the extraction of per- and polyfluoroalkyl substances (PFASs) from liquids such as water-containing liquids. PFASs include synthetic fluorinated organic compounds characterized by a hydrophobic carbon chain that is fully or partially saturated with fluorine atoms and form strong carbon-fluorine (C—F) bonds. As discussed, these robust bonds are responsible for their remarkable persistence in the environment, which has led to them being commonly referred to as ‘eternal chemicals’. Solvents of the present disclosure are capable of extracting PFAS compounds with excellent extraction efficiency over many extraction cycles, while maintaining the excellent extraction efficiency at broad ranges of solvent: feed ratios, pH values, temperatures, and mixing times.

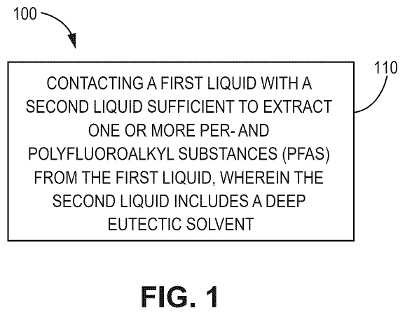

FIG. 1 illustrates method 100 for liquid-liquid extraction, according to some embodiments. Method 100 includes the following step:

At step 110, a first liquid is contacted with a second liquid sufficient to extract one or more per- and polyfluoroalkyl substances (PFASs) from the first liquid, wherein the second liquid includes a deep eutectic solvent. Therefore, the first liquid initially includes one or more PFASs. PFASs are examples of fluorinated hydrocarbon compounds that can be extracted according to the present disclosure. In one example, the first liquid includes water, such as a water-containing wastewater. In another example, the first liquid includes at least one PFAS and one or more of sodium chloride, ammonium chloride, urea, magnesium sulfate heptahydrate, peptone, glucose, oleic acid, anhydrous sodium sulfate, potassium dihydrogen phosphate, iron (III) chloride, and acetic acid. In yet another example, the first liquid includes one or more C—F bond containing compounds.

PFASs may follow the general formula: CₙF₂ₙ₊₁-R. In one example, PFASs refer to a group of one or more man-made chemicals having fully or partially fluorinated alkyl chains connected to various functional groups such as carboxylate, sulphonate, and phosphonate. These compounds have recently become a focal point of global concern and regulatory attention as micropollutants due to their persistence in the environment, toxicity, and bioaccumulation. The distinct chemical structure of PFASs, characterized by robust carbon-fluorine (C—F) bonds, makes them especially durable and resistant to water, oil, heat, and degradation. However, the very same properties that have led to the widespread use of PFASs cause them to be environmentally persistent and bio-accumulative, with serum elimination half-lives of 5.4 years and 3.8 years for perfluorooctanoic acid (PFOA) and perfluorooctane sulfonic acid (PFOS), respectively. Moreover, research has uncovered connections between exposure to PFASs and a range of health concerns, which encompass disruptions in immune and thyroid function, high cholesterol levels, kidney and liver damage, adverse reproductive and developmental effects, pregnancy-induced hypertension, and the potential risk of cancer. Accordingly, it is important to efficiently remove PFASs from the environment and water streams.

PFASs include one or more of perfluoroalkyl substances and polyfluoroalkyl substances. Accordingly, PFASs can include at least one of perfluoroalkyl acids (PFAAs), perfluoroalkane sulfonyl fluorides (PASFs), perfluoroalkyl iodides (PFAIs), per- and polyfluoroether carboxylic acids (PFECAs), per- and polyfluoroether sulfonic acids (PFESAs), fluoropolymers (FPs), side-chain fluorinated polymers, and perfluoropolyethers (PFPEs). Examples of PFAAs include perfluorocarboxylic acids (PFCAs), perfluoroalkane sulfonic acids (PFSAs), perfluoroalkyl phosphonic acids (PFPAs), and perfluoroalkyl phosphinic acids (PFPiAs).

Generally, perfluorocarboxylic acids follow the formula (1): CₙF₍₂ₙ₊₁₎CO₂H. In formula 1, n may range from 1 to 13. Perfluorocarboxylic acids include long-chain perfluorocarboxylic acids. Examples of perfluorocarboxylic acids include perfluoropropanoic acid, perfluorobutanoic acid, perfluoropentanoic acid, perfluorohexanoic acid, perfluoroheptanoic acid, perfluorooctanoic acid, perfluorononanoic acid, and perfluorodecanoic acid. Generally, perfluoroalkane sulfonic acids follow the formula (2): CₙF₍₂ₙ₊₁₎SO₃H. In formula 2, n may range from 3 to 10. Examples of perfluoroalkylsulfonic acids include perfluoropropanesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid. Examples of fluoropolymers (FPs) include polytetrafluoroethylene (PTFE), polyvinylidene fluoride (PVDF), fluorinated ethylene propylene (FEP), perfluoroalkoxyl polymer (PFA), and polyvinyl fluoride (PVF).

The initial concentration of PFASs in the first liquid may range from about 0.1 mg/L to about 5000 mg/L. In one example, the initial concentration of PFASs in the first liquid ranges from 100 mg/L to about 1500 mg/L. In another example, the initial concentration of PFASs in the first liquid ranges from 800 mg/L to about 1500 mg/L. In another example, the initial concentration of PFASs in the first liquid ranges from 500 mg/L to about 1200 mg/L. In one non-limiting example, the first liquid includes perfluorooctanoic acid, wherein the initial concentration of perfluorooctanoic acid in the first liquid ranges from about 0.1 mg/L to about 1500 mg/L. In another non-limiting example, the first liquid includes perfluorooctanoic acid, wherein the initial concentration of perfluorooctanoic acid in the first liquid ranges from about 500 mg/L to about 1200 mg/L.

In one example, the density of the first liquid ranges from about 0.9 g/mL to about 1.3 g/mL. In another example, the density of the first liquid ranges from about 0.95 g/mL to about 1.1 g/mL. The viscosity of the first liquid may range from about 0.7 mPa's to about 5 mPa's at 25° C. In one example, the viscosity of the first liquid may range from about 0.85 mPas to about 1 mPa's at 25° C.

As discussed, the second liquid includes one or more deep eutectic solvents. In one example, the deep eutectic solvent is a hydrophobic deep eutectic solvent mixture. The second liquid may consist of deep eutectic solvent(s). In one example, deep eutectic solvents are mixtures of a hydrogen bond donor and a hydrogen bond acceptor. Deep eutectic solvents may be formed by a combination of substances that exhibit substantially reduced freezing temperatures compared to their constituents. Since these deep eutectic solvents of the present disclosure are generally hydrophobic, these deep eutectic solvents have low water solubility and/or are substantially insoluble in water. The deep eutectic solvent can be insoluble in water, ensuring that the deep eutectic solvent does not leach into water. Further, the deep eutectic solvent of the present disclosure may be in the form of a liquid at room temperatures (such as about 20° C. to 25° C.). In one non-limiting example, the deep eutectic solvent of the present disclosure is hydrophobic and consists of a mixture of natural components and/or components derived from natural sources. These natural components can be environmentally friendly and biodegradable.

The deep eutectic solvent may include one or more compounds having a phosphine oxide group. The phosphine oxide group may be a hydrogen-accepting phosphine oxide (P═O) group that can form hydrogen bonds with the one or more PFASs. For example, the hydrogen-accepting phosphine oxide (P═O) group can form hydrogen bonds with the hydrogen-donating carboxylic acid group (COOH) of PFAS, such as PFOA. The P═O group can be a strong electron donor. Accordingly, the P═O group can provide a combination of hydrogen bonding and electron-donor-acceptor interactions with PFAS, resulting in a strong affinity between the two. This can enhance the extraction from the first liquid to the second liquid. Examples of deep eutectic solvents including a phosphine oxide group are trioctylphosphine oxide-containing deep eutectic solvents.

The deep eutectic solvent may include two or more of cineole, decanoic acid, thymol, lauric acid, menthol, trioctylphosphine oxide (TOPO), tetraoctylammonium chloride, camphor, N,N,N′,N′-tetramethyl-p-phenylenediamine, and octanoic acid. Examples of deep eutectic solvents include trioctylphosphine oxide: cineole, trioctylphosphine oxide: decanoic acid, trioctylphosphine oxide: thymol, tetraoctylammonium chloride: decanoic acid, trioctylphosphine oxide: lauric acid, trioctylphosphine oxide: menthol, camphor: menthol, N,N,N′,N′-tetramethyl-p-phenylenediamine: menthol, and octanoic acid: menthol. In one non-limiting example, the deep eutectic solvent includes trioctylphosphine oxide and one or more fatty acids, such as lauric acid and decanoic acid.

The deep eutectic solvent can include a first component and a second component, wherein the first component includes trioctylphosphine oxide, and wherein the second component includes a distinct component of the present disclosure. The second component may include a fatty acid. The deep eutectic solvent may include trioctylphosphine oxide, wherein the weight percentage of trioctylphosphine oxide in the deep eutectic solvent is above 50 wt. %. For example, the weight percentage of trioctylphosphine oxide in the deep eutectic solvent may be greater than 60 wt. %. The concentration of trioctylphosphine oxide in the deep eutectic solvent may be greater than 1 mol/L. For example, the concentration of trioctylphosphine oxide in the deep eutectic solvent may be greater than 1.4 mol/L. Concentrations of trioctylphosphine oxide of the present disclosure can eliminate the need for potentially hazardous organic diluents.

As discussed, the deep eutectic solvent can include a first component and a second component, wherein the first component includes trioctylphosphine oxide, and wherein the second component includes a distinct component of the present disclosure. The second component can include one or more hydrogen bond donors. Examples of hydrogen bond donors include long chain alcohols (such as hexanol to octadecanol), long chain fatty acids (such as hexanoic acid to octadecanoic acid), terpenes (natural components derived from plants such as menthol, thymol, and camphor), terpenoids (chemically modified derivatives of terpenes such as carvone, geraniol, and limonene), and quaternary ammonium salts (organic salts with a quaternary ammonium cation such as tetrabutylammonium chloride and methyltrioctylammonium chloride). Further examples of hydrogen bond donors include organic acids (such as benzoic acid, phenylacetic acid, and cinnamic acid), phenols (aromatic compounds with hydroxyl groups such as cresol and eugenol), esters (such as propyl butyrate and methyl laurate), and fatty acid esters (esters derived from fatty acids such as isopropyl myristate and ethyl oleate). Deep eutectic solvents of the present paragraph can maintain liquidity at ambient conditions.

Further, trioctylphosphine oxide, containing three hydrophobic octyl chains, leads to strong hydrophobic interactions between PFAS and trioctylphosphine oxide. For example, when extracting PFOA, trioctylphosphine oxide effectively extracts PFOA due to strong hydrophobic interactions between the perfluoroalkyl tail of PFOA and the alkyl chains of trioctylphosphine oxide. These interactions can facilitate the effective solubilization of PFOA within the deep eutectic solvent. Van der Waals forces also contribute to the affinity between PFOA and trioctylphosphine oxide. The proximity allowed by the molecular structures of trioctylphosphine oxide and PFOA enables these cumulative forces to enhance the miscibility and stabilization of PFOA within the deep eutectic solvent phase.

In one example, the deep eutectic solvent includes trioctylphosphine oxide and lauric acid, wherein a molar ratio of trioctylphosphine oxide to lauric acid ranges from about 3:1 to about 1:3. Lauric acid is a non-toxic fatty acid derived from natural sources, such as palm oil, coconut oil, and milk. In another example, the deep eutectic solvent includes trioctylphosphine oxide and lauric acid, wherein a molar ratio of trioctylphosphine oxide to lauric acid ranges from about 1:1 to about 1:2. In yet another example, the deep eutectic solvent includes trioctylphosphine oxide and lauric acid, wherein a molar ratio of trioctylphosphine oxide to lauric acid is about 1:1.

In one example, the deep eutectic solvent includes trioctylphosphine oxide and decanoic acid, wherein a molar ratio of trioctylphosphine oxide to decanoic acid ranges from about 3:1 to about 1:3. Decanoic acid, also referred to as capric acid, is a straight-chain fatty acid. Decanoic acid may be derived from coconut and palm oils, for example. In another example, the deep eutectic solvent includes trioctylphosphine oxide and decanoic acid, wherein a molar ratio of trioctylphosphine oxide to decanoic acid ranges from about 1:1 to about 1:2. In yet another example, the deep eutectic solvent includes trioctylphosphine oxide and decanoic acid, wherein a molar ratio of trioctylphosphine oxide to decanoic acid is about 1:1.

The density of the second liquid may be at least 0.85 g/mL. In one example, the density of the second liquid ranges from about 0.85 g/mL to about 1.10 g/mL. In another example, the density of the second liquid ranges from about 0.85 g/mL to about 1 g/mL. The density of the second liquid may be less than 1 g/mL. The viscosity of the second liquid at 25° C. may be greater than 5 mPas. In one example, the viscosity of the second liquid at 25° C. ranges from about 10 mPa's to about 120 mPas. In another example, the viscosity of the second liquid at 25° C. ranges from about 30 mPa's to about 80 mPas, about 40 mPa's to about 80 mPa's, and/or about 45 mPa's to about 55 mPa·s. Importantly, the viscosity of the second liquid at 25° C. may be less than 120 mPa·s. For example, if the viscosity of the second liquid is greater than 120 mPas, the higher viscosity can increase operational costs due to increased energy required for pumping. Further, solvents with higher viscosities can hinder the mass transfer between phases, resulting in longer extraction times.

Deep eutectic solvents can be prepared using agitation and controlled heating. For example, the hydrogen bond donor and the hydrogen bond acceptor can be mixed at a desired molar ratio. The mixture can be heated and/or mixed using a temperature-controlled mixing device. For example, the mixture can be heated to/at a temperature ranging from about 50° C. to about 100° C. In one example, the mixture is heated to about 70° C. for about 1 hour in a temperature-controlled shaking device. The formed mixture may then be cooled, such as to room temperature, and the formed mixture is generally a liquid at room temperature. In one non-limiting example, the deep eutectic solvent is a substantially clear liquid at room temperature.

Compared to traditional solvents such as traditional organic solvents that pose significant ecological threats due to toxicity and volatility, deep eutectic solvents of the present disclosure may be natural deep eutectic solvents with low toxicity and low volatility. Compared to conventional ionic liquids, deep eutectic solvents of the present disclosure provide reduced cost, much greater extraction efficiencies, and enhanced reusability. These deep eutectic solvents exhibit low volatility, can be easily produced, and are low cost. Further, these deep eutectic solvents of the present disclosure can be tuned (density, polarity, hydrophobicity) according to the specific water and PFAS compositions to be extracted.

Importantly, a density difference between a first density of the first liquid and a second density of the second liquid may be at least 0.05 g/mL. In one example, a density difference between a first density of the first liquid and a second density of the second liquid is at least 0.1 g/mL. In yet another example, a density difference between a first density of the first liquid and a second density of the second liquid is at least 0.15 g/mL. Density differences of the present disclosure are important for facilitating separation. The effectiveness of liquid extraction can be influenced by this density difference. In one example, the volume ratio of the second liquid to the first liquid being contacted ranges from about 1:1 to about 1:7. In another example, the volume ratio of the second liquid to the first liquid being contacted ranges from about 1:1 to about 1:3. In yet another example, the volume ratio of the second liquid to the first liquid being contacted is about 1:1.

Contacting the first liquid and the second liquid may include mixing, physically contacting, and/or heating the first liquid and the second liquid. The first liquid and the second liquid may be mixed for a time ranging from 5 seconds to 2 hours. In one example, the first liquid and the second liquid are mixed for 10 seconds to 5 minutes. In another example, the first liquid and the second liquid are mixed for 20 seconds to 2 minutes. For example, the first liquid and the second liquid may be mixed for about 1 minute. Compared to adsorption and membrane processes, extraction methods of the present disclosure can be completed in less time and with high extraction efficiencies.

The extraction may be performed at various pH values. In one example, the extraction of PFASs is performed at a pH value ranging from about 3 to about 13. In another example, the extraction of PFASs is performed at a pH value ranging from about 3 to about 9. In one non-limiting example, the extraction efficiency may decrease at pH values above about 11. The extraction may be performed at various temperatures. In one example, the extraction of PFASs is performed at a temperature ranging from about 15° C. to about 150° C. In another example, the extraction of PFASs is performed at a temperature ranging from about 20° C. to about 100° C. Contacting the first liquid and the second liquid and extracting PFASs from the first liquid may be performed in a liquid-liquid extraction unit. Contacting the first liquid and the second liquid may include using a mixer and/or centrifuge.

The extraction efficiency of PFASs from the first liquid to the second liquid may be greater than 80%. In one example, the extraction efficiency of PFASs from the first liquid to the second liquid is greater than 85%. In another example, the extraction efficiency of PFASs from the first liquid to the second liquid is greater than 90%. The extraction efficiency of PFASs from the first liquid to the second liquid may be greater than 92%, greater than 94%, greater than 96%, greater than 98%, and/or greater than 99%. As discussed, the one or more PFASs may include PFOA. In one example, the extraction efficiency of PFOA from the first liquid to the second liquid may be greater than 90%, greater than 95%, and/or greater than 98%.

Importantly, the second liquid may be reused after extracting PFASs from the first liquid. Accordingly, the second liquid may be reused for two or more extraction cycles. In one example, the second liquid may be reused for seven or more extraction cycles. The reusability increases the efficiency of the extraction process. Further, the second liquid can be reused without substantially lowering the extraction efficiency.

In comparison, adsorption and membrane processes are not as effective and efficient at removing PFASs from the environment or water. For example, adsorption materials commonly suffer from gradual loss in their removal efficiency and selectivity, poor mass transfer limitations, particularly for short-chain PFASs, and technoeconomic challenges associated with the regeneration and recyclability of spent adsorbents. Furthermore, the effectiveness of the adsorptive removal of PFASs is substantially compromised when faced with natural organic materials (NOMs) and additional contaminants, which are often found at significantly exceeding concentrations in contaminated water bodies and wastewater. Further, high-pressure membrane systems are prone to membrane fouling. This issue becomes particularly acute under conditions involving NOMs and suspended matter, significantly diminishing operational efficiency of these systems. Hence, in comparison to adsorption and membrane processes, the liquid-liquid extraction solvents and methods of the present disclosure exhibit higher extraction efficiency, improved selectivity and versatility, lower energy requirements, and enhanced scalability.

Importantly, the second liquid of the present disclosure (including one or more deep eutectic solvents) is capable of extracting at least one type of PFASs from a distinct liquid, such as a water-containing liquid. These unique deep eutectic solvents have strong interactions with PFAS molecules. Further, these deep eutectic solvents of the present disclosure are capable of extracting PFASs at high single-stage extraction efficiencies and can be reused for multiple cycles. The extractions can be performed at broad pH values, temperature ranges, and solvent: feed ratios. Further, these deep eutectic solvents can extract PFASs from water at varying initial PFAS concentrations.

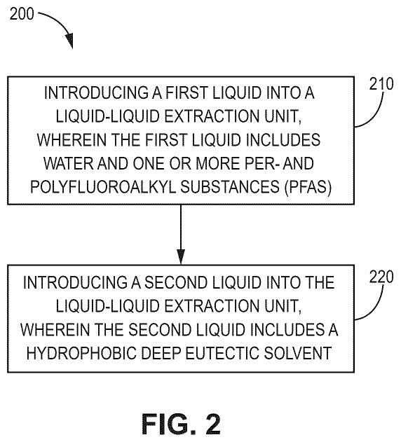

FIG. 2 illustrates method 200 for liquid-liquid extraction, according to some embodiments. Method 200 includes the following steps (with various orders possible):

At step 210, a first liquid is introduced into a liquid-liquid extraction unit, wherein the first liquid includes water and one or more PFASs (such as PFASs discussed in the present disclosure). The first liquid may be introduced into the liquid-liquid extraction unit through a first inlet of the liquid-liquid extraction unit. The first liquid in method 200 may be the same first liquid as described in method 100. At step 220, a second liquid is introduced into the liquid-liquid extraction unit, wherein the second liquid includes a hydrophobic deep eutectic solvent having a viscosity less than 120 mPa's at 25° C. The second liquid may be introduced into the liquid-liquid extraction unit through the first inlet or through a second inlet of the liquid-liquid extraction unit. The second liquid may be the same second liquid as described in method 100. The first liquid and the second liquid may be introduced into the liquid-liquid extraction unit sufficient for the first liquid and the second liquid to be contacted and/or mixed.

The liquid-liquid extraction unit of method 200 may include a centrifugal extractor and/or a rotating disc extractor. The liquid-liquid extraction unit of method 200 may include a mixing device and/or a heating device. In one example, the liquid-liquid extraction unit of method 200 is capable of forming a raffinate product stream and an extract product stream. For example, the initial concentration of PFASs in the first liquid entering the liquid-liquid extraction unit may be at least 80× greater than a concentration of PFASs in the raffinate product stream. The raffinate stream is the liquid stream formed/remaining that had the solute at least partially removed. The raffinate stream may exit the liquid-liquid extraction unit via an outlet. In one example, the initial concentration of PFASs in the first liquid entering the liquid-liquid extraction unit is at least 90× greater than the concentration of PFASs in the raffinate product stream. In another example, over 90% of the PFAS(s) in the first liquid are extracted to the extract product stream.

Method 200 may include mixing the first liquid and the second liquid. The first liquid and the second liquid may be mixed for a time ranging from 5 seconds to 2 hours. In one example, the first liquid and the second liquid are mixed for 10 seconds to 5 minutes. In another example, the first liquid and the second liquid are mixed for 20 seconds to 2 minutes. For example, the first liquid and the second liquid may be mixed for about 1 minute. The volume ratio of introduced second liquid to introduced first liquid may range from about 1:1 to about 1:7. In one example, the volume ratio of introduced second liquid to introduced first liquid ranges from about 1:1 to about 1:3.

Method 200 may be performed at various pH values. In one example, the extraction of PFASs is performed at a pH value ranging from about 3 to about 13. Various acids or bases may be introduced to adjust the pH value to this range. In another example, the extraction of PFASs is performed at a pH value ranging from about 3 to about 9. The extraction may be performed at various temperatures. In one example, the extraction of PFASs in method 200 is performed at a temperature ranging from about 15° C. to about 150° C. In another example, the extraction of PFASs is performed at a temperature ranging from about 20° C. to about 100° C.

The extraction efficiency of one or more PFASs (using method 200) from the first liquid to the second liquid may be greater than 80%. In one example, the extraction efficiency of PFASs from the first liquid to the second liquid is greater than 85%. In another example, the extraction efficiency of PFASs from the first liquid to the second liquid is greater than 90%. The extraction efficiency of PFASs from the first liquid to the second liquid may be greater than 92%, greater than 94%, greater than 96%, greater than 98%, and/or greater than 99%. Importantly, the second liquid may be reused after extracting PFASs from the first liquid. Accordingly, the second liquid may be reused for two or more extraction cycles. In one example, the second liquid may be reused for seven or more extraction cycles. The reusability increases the efficiency of the extraction process.

As discussed, embodiments of the present disclosure include deep eutectic solvent compositions. Deep eutectic solvent compositions can include the deep eutectic solvents utilized in method 100 and method 200. In one example, the deep eutectic solvent composition includes a liquid mixture including a first component and a second component, wherein the first component includes one or more compounds having a phosphine oxide group, and wherein the second component includes a fatty acid. In another example, the deep eutectic solvent composition includes a liquid mixture including a first component and a second component, wherein the first component includes trioctylphosphine oxide (TOPO), and wherein the second component includes at least one of lauric acid and decanoic acid, wherein the liquid mixture has a viscosity less than about 120 mPa's at 25° C. The viscosity of the liquid mixture may be greater than about 10 mPa's at 25° C., and the density of the liquid mixture may be less than 0.95 g/mL. The molar ratio of the first component to the second component may be about 1:1. In one example, the weight percentage of TOPO in the liquid mixture may be greater than about 50 wt. %.

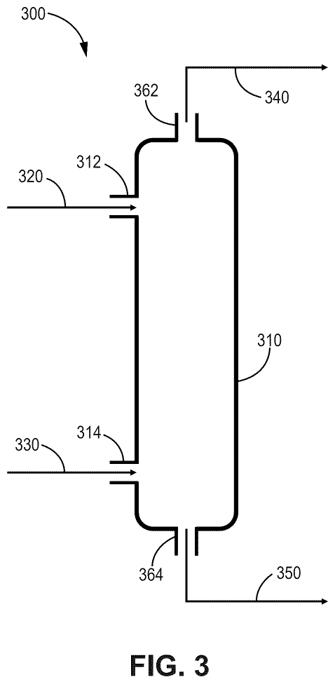

FIG. 3 illustrates extraction system 300, according to some embodiments. Extraction system 300 includes a vessel 310, and the vessel 310 includes a first inlet 312, a second inlet 314, a first outlet 362, and a second outlet 364. A feed stream 320 may be introduced into vessel 310 via the first inlet 312, and a solvent stream 330 may be introduced into vessel 310 via the second inlet 314. Extraction system 300 is capable of forming an extract product stream 340 and a raffinate product stream 350. The extract product stream 340 may exit vessel 310 via the first outlet 362, and the raffinate product stream 350 may exit the vessel 310 via the second outlet 364. A mixing device may be utilized within the vessel 310 for mixing the liquids in the vessel 310. Further, extraction system 300 may utilize a heating device to heat components (to temperatures of the present disclosure) within vessel 310 during the extraction process.

Feed stream 320 may include liquids of the present disclosure (such as water) and one or more fluorinated hydrocarbons, such as PFASs. Solvent stream 330 may include one or more deep eutectic solvents of the present disclosure. Raffinate product stream 350 may include water as the major component, and extract product stream 340 may include the deep eutectic solvent as the major component, as well as extracted PFASs from the feed stream 320. The stream and inlet/outlet positions in extraction system 300 are not particularly limited, and other embodiments are possible. For example, extraction systems may position the feed and solvent inlets at various positions on/within the extraction vessel to maximize extraction efficiency.

Extraction system 300 may include extractors such as a centrifugal extractor or a rotating disc extractor. For example, a centrifugal extractor can utilize a rotor to mix the liquids and to separate the liquids. Centrifugal separators may utilize counter-current flow of fluids. A rotating disc extractor may include a rotating shaft with discs to agitate and/or mix the fluids. Accordingly, the liquids may be mechanically agitated. A rotating disc extractor may also utilize counter-current flow of fluids. Extraction systems may further include baffles and/or blades to assist with separation. These extraction systems can be used in municipal water treatment facilities, industrial wastewater treatment, and remediation projects for contaminated groundwater sources.

### Example 1—Deep Eutectic Solvents and Liquid-Liquid Extraction

Compounds and materials utilized include: perfluorooctanoic acid (PFOA, 95%), perfluoroheptanoic acid (PFHA, ≥97%), trioctylphosphine oxide (TOPO, 99%), thymol (Thy, ≥98.5%), trimethylpentanediol (TMPD, 97%), decanoic acid (DecA, ≥98%), camphor (Cam, 99%), coumarin (Cou, 98%), octanoic acid (OctA, ≥98, lauric acid (LauA, 98%), toluene (Tol, ≥98%), L-menthol (Men, 99.5%), acetic acid (AA, ≥99%), and methanol (MeOH, ≥99.9%).

The (natural) deep eutectic solvents (referred to hereafter as “DESs”) were prepared by agitation and controlled heating. Initially, the hydrogen bond acceptors (HBAs) and hydrogen bond donors (HBDs) were mixed at a specified molar ratio. This mixture was heated to 70° C. for 1 h in a temperature-controlled shaking device to facilitate the formation of a homogeneous liquid. Upon preparation, DESs were cooled to room temperature (25° C.), ensuring their anti-solidification and liquid uniformity for further experimental use. The formation of DESs was indicated by the presence of a clear liquid at room temperature, signifying substantial reduction in the melting point compared to that of the starting components.

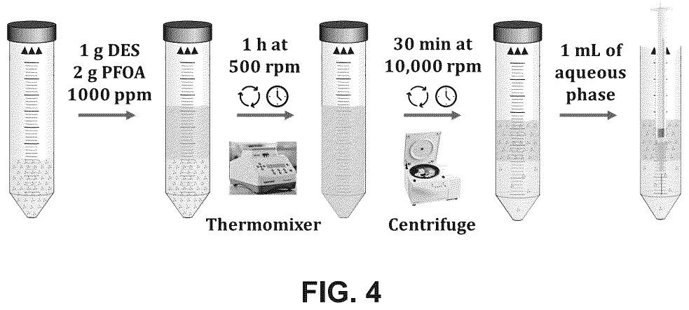

FIG. 4 illustrates an example method of extraction, according to some embodiments. A 2 L aqueous stock solution of 1000 mg/L PFOA was carefully prepared using deionized (DI) water and was used to prepare different dilutions. To prepare a 1000 ppm PFOA solution, 1000 mg of PFOA powder was measured using an accurate weighing scale, and the weighed amount was transferred into a glass bottle. Then, 500 mL of deionized water was added to the bottle and mixed in an incubator shaker until the PFOA was completely dissolved. In one example, it is important to dissolve the PFOA completely to ensure a homogeneous solution. Once the PFOA was dissolved, the remaining amount of water to reach the desired final volume (1000 mL mark) was added. The solution was again mixed in the incubator shaker to ensure a homogenous solution. Concentrated aqueous hydrochloric acid (HCl) and sodium hydroxide (NaOH) solutions were used to adjust the pH of the PFOA solutions.

For extraction studies, the DESs and PFOA solutions were combined in 50 mL polyethylene centrifuge tubes at an S: F volume ratio of 1:2. The biphasic mixture was stirred for 1 h at 500 rpm in a temperature-regulated shaker at 25° C. The mixtures were then centrifuged for 30 min at 10,000 rpm to ensure thorough separation of the two phases. Post-centrifugation, 1 mL aliquots were carefully sampled from the aqueous phase using a syringe for analysis, with care not to disturb the boundary between the phases. In another example, the prepared mixtures were mixed for 1 h at 1000 rpm and 298.2 K in a mixer. The mixtures were then centrifuged for 20 min at 9000 rpm to get phase separation between the DES and water. Finally, 1 mL was taken from the raffinate phase using a syringe with a needle for analysis ensuring not to disturb the coexistence interface between the two phases. The extraction efficiency (E) was calculated according to Equation E1.

$$E ( \% ) = ( 1 - \frac{{C}_{f}}{{C}_{0}} ) \times 100 \% \qquad ( E1 )$$

where the PFOA concentrations (mg/L) before and after extraction are denoted by C₀ and C_{f}, respectively.

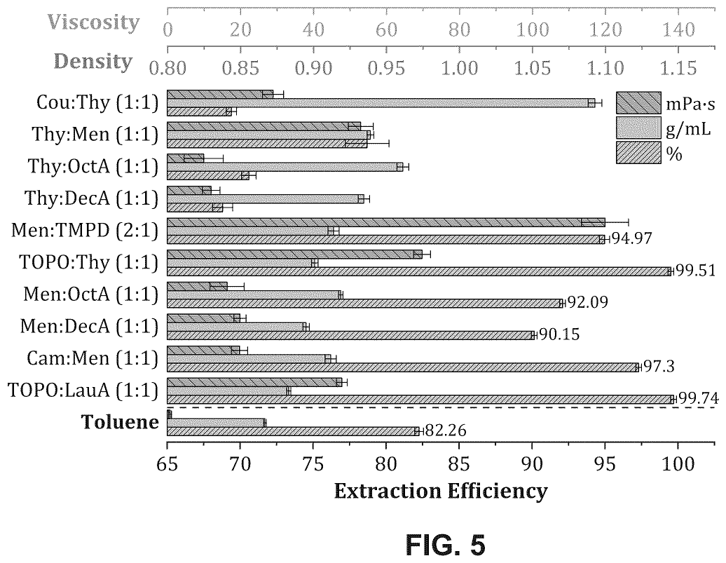

FIG. 5 illustrates extraction efficiency, density, and viscosity of various extraction solvents, according to some embodiments. As illustrated in FIG. 5, the extraction efficiency, density, and viscosity of each DES were in the range of 68.79-99.74%, 0.88-1.09 g/mL, and 10-120 mPa·s, respectively. This shows the importance of the chemical composition of the selected DES in determining physical properties and PFOA extraction efficiency. The efficiency of DES incorporating TOPO far surpassed that of toluene. TOPO: LauA (1:1) achieved an efficiency of 99.74%. Table 1 shows the extraction efficiencies of various deep eutectic solvents of the present disclosure.

TABLE 1
Extraction Efficiencies of various deep eutectic solvents.

| | | Extraction |
|---|---|---|
| Eutectic Solvent | Ratio | Efficiency |
| Trioctylphosphine oxide:Cineole | 1:8 | 99.94% ± 0.03 |
| Decanoic acid: Trioctylphosphine oxide | 1:1 | 99.84% ± 0.02 |
| Thymol:Trioctylphosphine oxide | 1:1 | 99.74% ± 0.02 |
| Tetraoctylammonium chloride:Decanoic acid | 1:2 | 99.74% ± 0.02 |
| Lauric acid:Trioctylphosphine oxide | 1:1 | 99.41% ± 0.02 |
| Menthol:Trioctylphosphine oxide | 3:1 | 98.99% ± 0.02 |
| Menthol:Camphor | 1:1 | 96.24% ± 0.04 |
| Menthol:N,N,N′,N′-Tetramethyl-p- | 2:1 | 94.25% ± 0.03 |
| phenylenediamine | | |
| Thymol:Trioctylphosphine oxide | 3:1 | 91.83% ± 0.07 |
| Octanoic acid:Menthol | 1:1 | 91.32% ± 0.10 |

The viscosity of the solvent is another important factor for effective extraction. DESs conventionally exhibit high viscosity at room temperature, often exceeding 1000 mPa·s, which is largely attributed to the extensive hydrogen-bonding network formed between solvent components. The specific viscosity of any eutectic mixture can vary significantly and is influenced by several key factors: the chemical nature of its constituents, molar ratio of HBA to HBD, temperature, and water content. These factors collectively influence the fluidity of DES, highlighting the intricate molecular interactions within these distinctive solvent systems. Solvents with higher viscosities can hinder the mass transfer between phases, resulting in longer extraction times. Moreover, solvents with higher viscosity can increase operational costs due to the increased energy required for pumping and other processing challenges. The viscosities of the tested DES were less than 100 mPa·s, with the exception of Men: TMPD, which had a viscosity of 120 mPa·s.

Furthermore, the effectiveness of liquid extraction is significantly influenced by the density difference between the two phases, as this difference plays an important role in facilitating separation. Among the studied DES, those displaying minimal density differentials were predominantly thymol-based and included Thy: OctA, Thy: DecA, and Thy: Men. This can be attributed to thymol's inherent density at 25° C., which is close to that of water (0.967 g/mL). Conversely, DESs exhibiting density differentials greater than 0.1 g/mL, included TOPO: LauA and Men: DecA. In one example, a minimum density difference of at least 0.1 g/mL is desired between the solvent and aqueous phase. TOPO: LauA displayed the highest extraction efficiency (99.74%), largest density differential (0.117 g/mL), and relatively low and manageable viscosity of 48 mPa·s. Importantly, TOPO: LauA achieved removal efficiencies of 99.92% and 99.71% for PFOA and PFHpA (perfluoroheptanoic acid), respectively.

### Example 2—TOPO: LauA Deep Eutectic Solvent for Extraction of PFASs Including PFOA and PFHA/PFHpA

In TOPO: LauA (1:1), lauric acid serves as the HBD. It is an inexpensive, non-toxic fatty acid derived naturally from palm and coconut oil and certain types of milk, making it safe to handle and environmentally friendly. Furthermore, the long chain of lauric acid can strengthen hydrophobic interactions with PFOA, facilitating its extraction from water. On the other hand, TOPO, well-known for its commercial availability, and cost effectiveness, is ideal for PFOA removal because of its lipophilic nature and HBA potential. In contrast to industrial diluent combinations such as kerosene containing components, the TOPO: LauA 1:1 system features a substantial TOPO concentration of 1.5 mol/L (66 wt %), which is significantly higher than that of industrial diluents. This high concentration of TOPO in the eutectic mixture eliminates the need for potentially hazardous organic diluents, offering a green and sustainable approach for utilizing TOPO as a liquefied extracting agent.

TOPO is a polar molecule with a hydrogen-accepting phosphine oxide (P═O) group that can form hydrogen bonds with the hydrogen-donating carboxylic acid group (COOH) of PFOA. Additionally, the P═O group in TOPO is a strong electron donor, while the perfluoroalkyl group (C₇F₁₅—) in PFOA is highly electron-withdrawing. The combination of hydrogen bonding and electron donor-acceptor interactions between TOPO and PFOA results in a strong affinity between the two molecules, enhancing the extraction from the aqueous phase into the DES phase.

The efficiency of TOPO-based DESs in extracting PFOA can be influenced by hydrophobic and Van der Waals interactions. PFOA, characterized by a long perfluoroalkyl tail (C7F15-), exhibits significant hydrophobicity akin to other perfluorinated compounds. TOPO contains three hydrophobic octyl chains (3xC8H17-), leading to strong hydrophobic interactions between the perfluoroalkyl tail of PFOA and the alkyl chains of TOPO. These interactions facilitate the effective solubilization of PFOA within the DES, aiding its extraction. Additionally, Van der Waals forces, though individually weaker than hydrogen bonds, significantly contribute to the affinity between TOPO and PFOA. The close proximity allowed by the molecular structures of TOPO and PFOA enables these cumulative forces to enhance the miscibility and stabilization of PFOA within the DES phase. This effect is accentuated given the large surface areas of the interacting molecules, providing a comprehensive mechanism for the efficient extraction of PFOA by TOPO-based DESs. The formation of a DES with TOPO and a hydrophobic hydrogen bond donor creates a highly structured solvent environment that can effectively solvate and extract PFOA.

A qualitative toxicity assessment based on the available median lethal dose (LD50) data was conducted. The LD50 metric serves as a critical indicator of toxicity, with low values denoting high toxicities. Lauric acid displayed a notably low toxicity profile, demonstrated by an LD50 (oral, rat) value of 12,000 mg/kg, demonstrating its lower toxicity than choline chloride, which is recognized for its eco-friendly attributes, with an LD50 (oral, rat) of 3,900 mg/kg. Conversely, TOPO has an LD50 (oral, rat) of 2,000 mg/kg. However, its significant hydrophobic nature, demonstrated by a water solubility of only 0.15 mg/L, minimizes bioavailability risks. Bioavailability denotes the extent and speed with which an organism uptakes a compound. This minimal water affinity of TOPO substantially lowers the likelihood of body absorption, thereby mitigating potential adverse effects and enhancing its suitability. Similarly, LauA exhibits a pronounced hydrophobic profile with water solubility of only 0.4 mg/L, further underscoring its safety profile.

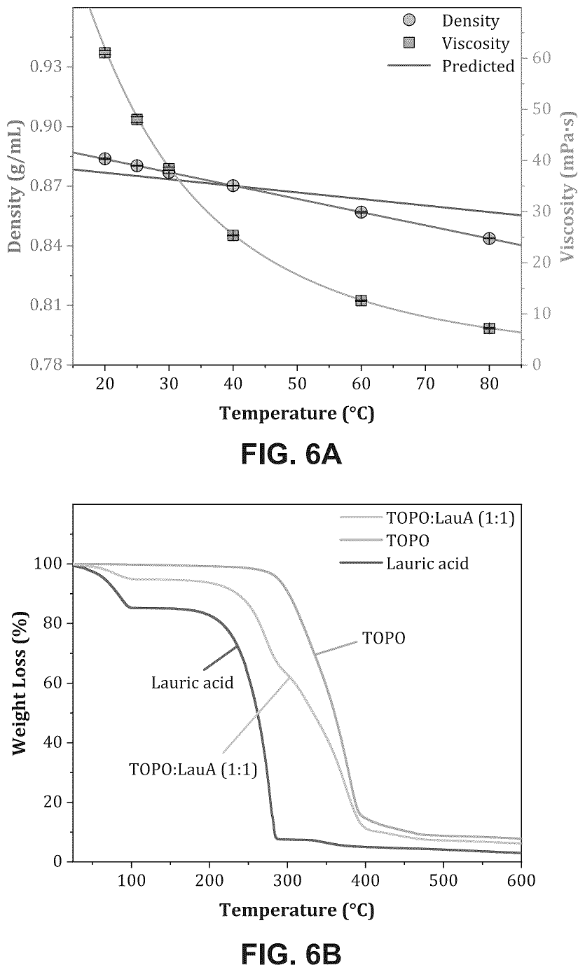

FIG. 6A illustrates density, viscosity, and predicted values with temperature for TOPO: LauA (1:1), according to some embodiments. The density of TOPO: LauA across the temperature range of 20-80° C. is depicted in FIG. 6A, and was modeled using linear regression with Equation E2:

$$ρ = a + bT \qquad ( E2 )$$

where density (p, g/mL) is a function of temperature (T, ° C.), with ‘a’ and ‘b’ being the regression parameters. The fit accuracy, evaluated by the coefficient of determination (R²), was 0.9999, and the parameters values are presented in Table 2. The density of TOPO: LauA at 25° C. was measured to be 0.880±0.001 g/mL, indicating that TOPO: LauA is less dense than water and forms the upper phase. The viscosities of TOPO: LauA at temperatures ranging from 20° C. to 80° C. are also shown in FIG. 6A and were modeled with the Vogel-Fulcher-Tammann (VFT) Equation E3:

$$μ = A exp ( \frac{B}{T - C} ) \qquad ( E3 )$$

where viscosity (u, in mPa-s) is a function of temperature (T, in ° C.). The estimates of the VFT parameters are listed in Table 2, and the R² for the fit is 0.9999. The viscosity of TOPO: LauA at 25° C. was measured to be 48.026±0.039 mPa·s. A relatively low viscosity is beneficial for achieving faster diffusion rates in the solvent phase, which is crucial for operational effectiveness.

TABLE 2
Density and viscosity parameters for linear regression
and VFT equation, respectively, for TOPO:LauA (1:1).

| Parameter | Estimate |
|---|---|
| Density | |
| a (g/mL/° C.) | −6.67 × 10⁻⁴ |
| b (g/mL) | 0.897 |
| R² | 0.9999 |
| Viscosity | |
| A (mPa · s) | 3.599 × 10⁻² |
| B (° C.) | 1107.91 |
| C (° C.) | −128.97 |
| R² | 0.9999 |

FIG. 6B illustrates thermogravimetric profiles of TOPO, LauA, and TOPO: LauA (1:1), according to some embodiments. Thermogravimetric analysis is another essential solvent characterization method and is vital for identifying the maximum operational temperature range of a solvent. The onset decomposition temperature (Tₒₙₛₑₜ) marks the start of a noticeable weight loss, indicating initial thermal degradation. Table 3 lists the onset temperatures for TOPO: LauA (1:1), and its thermogravimetric profile is shown in FIG. 6B along with the profiles of pure TOPO and lauric acid for comparison. Hydrogen bonding plays an important role in DES stability by reducing molecular volatility and increasing the energy needed for decomposition. With Tₒₙₛₑₜ being particularly dependent on the stability of the HBD; more stable HBDs result in higher Tₒₙₛₑₜ values for DES. This is evidenced in TOPO: LauA (1:1), which has an onset temperature of 232° C., which is higher than that of lauric acid (207° C.), but also lower than that of pure TOPO (281° C.). This intermediate Tₒₙₛₑₜ reflects the delicate balance of H-bonding strength in the DES that is affected from both the stability of the individual components and the new interactions they form when combined.

TABLE 3
Physical properties of TOPO:LauA (1:1) at 25° C., along
with its thermal properties, critical properties, average
molecular mass, and extraction efficiency of PFOA and PFHA.

| Property | Value | Unit |
|---|---|---|
| Experimental properties | | |
| Density | 0.880 ± 0.001 | g/mL |
| Viscosity | 48.026 ± 0.039 | mPa · s |
| Onset decomposition temperature | 232 ± 1 | ° C. |
| Water content^{a} | 0.287 ± 0.037 | wt % |
| Water solubility^{b} | 1.562 ± 0.160 | wt % |
| Leachability (TOC)^{c} | 0.225 ± 0.021 | g/L |
| PFOA extraction efficiency | 99.74 ± 0.01 | % |
| PFHA extraction efficiency | 99.46 ± 0.02 | % |
| Calculated properties | | |
| Critical temperature | 869.1 | ° C. |
| Critical pressure | 13.76 | bar |
| Critical volume | 1101.9 | mL/mol |
| Acentric factor | 0.949 | — |
| Molecular weight | 293.48 | g/mol |

^{a}Weight percentage of water in the freshly prepared deep eutectic solvent (DES) prior to water contact.
^{b}Weight percentage of water in the DES after water contact.
^{c}Concentration of DES in water after DES contact measured as Total Organic Carbon (TOC).

Due to the hydrogen bonding between components, DESs typically exhibit hydrophilic characteristics that facilitate their dissolution in water. However, the hydrophobic or hydrophilic character of a deep eutectic solvent is largely determined by the structure of its constituent HBD and HBA components. DESs composed entirely of hydrophobic compounds tend to be more stable in water than those that include both hydrophilic and hydrophobic compounds, highlighting the important role of the component composition in determining the water-related stability of DESs.

The water content of the prepared TOPO: LauA was 0.287±0.037 wt %, indicating a low inherent moisture level. This low water content is indicative of the hydrophobic nature of the DES, suggesting that the solvent composition and structure inherently prevent water incorporation. Upon mixing TOPO: LauA with an equal amount of water for 1 h, the water content of the TOPO: LauA increased to 1.562±0.160 wt %, reinforcing the limited affinity for water.

Furthermore, the solubility of TOPO: LauA in water, as measured by TOC content, provides additional clarity regarding its interaction with water. A low leachability value of 0.225±0.021 g/L showed minimal solubility in water. To further confirm the TOC results, samples after water contact were also analyzed using FT-IR. The results showed that no peaks indicative of TOPO or LauA were observed. This low solubility is likely a result of hydrophobic interactions within the DES, which prevent substantial dissolution in an aqueous medium. Despite the low solubility of DES components in water, they originate from natural sources and are generally recognized as safe and non-toxic, showing that their limited transfer into water is unlikely to increase the toxicity profile of water. Moreover, the leachability of DES was notably low, approximately 0.02 wt %, suggesting that a further separation step may not be required to extract DES from wastewater. This minimal leachability, coupled with the safety profiles of the components, highlights its practicality in applications where environmental sustainability and low ecological impact are important, such as wastewater treatment.

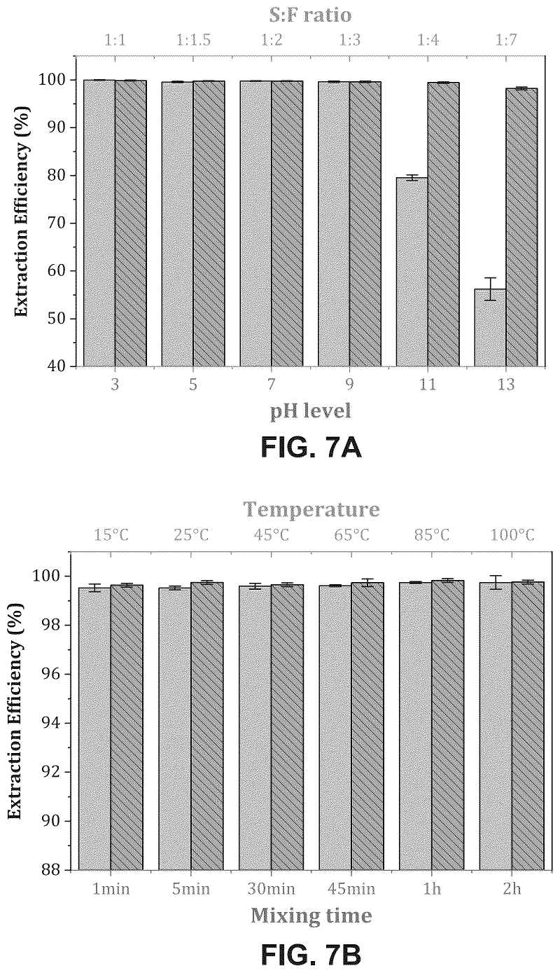

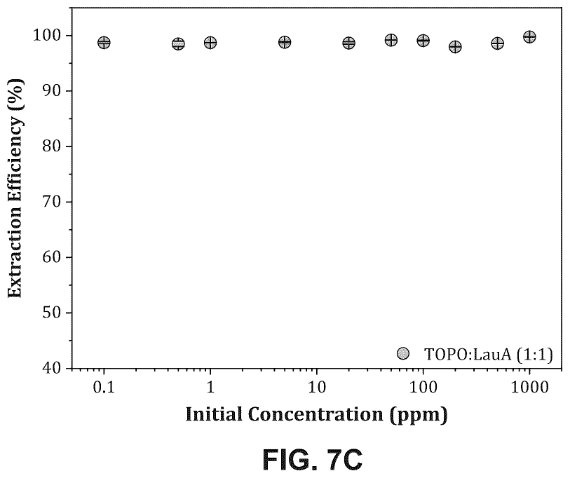

FIG. 7A illustrates the influence of pH and solvent: feed ratio on TOPO: LauA-PFOA extraction performance, according to some embodiments. Experiments were conducted over a pH value range of 3-13. In one example, at acidic to slightly alkaline pH levels (pH 3-9), the extraction efficiency remained remarkably high, ranging between 99.95 and 99.55%, indicating the efficacy of TOPO: LauA over a varied pH range. In another example, under more alkaline conditions (pH=11 and pH=13), the extraction efficiency significantly dropped to 79.54±0.30% and 56.21±2.38%, respectively. For example, these results indicate that the extraction efficiency of PFOA is can be influenced by its ionization behavior, which also varies with the pH. In low-pH environments, the presence of both protonated and anionic forms of PFOA facilitates efficient extraction. However, as the pH increases, the molecule increasingly adopts an anionic state (—COO—), resulting in greater hydrophilicity and water solubility.

The S: F (v/v) ratio in liquid extraction is another important parameter that significantly influences not only the extraction efficiency but also the cost, ease of phase separation, equipment design, and sustainability of the process. Thus, a set of experiments were conducted to assess the extraction of PFOA at S: F ratios of 1:1, 1:1.5, 1:2, 1:3, 1:4, and 1:7 (v/v), as illustrated in FIG. 7A. Contrary to the typical trend in liquid extraction, where efficiency declines rapidly with a reduced S: F (v/v) ratio, TOPO: LauA consistently maintained high efficiency, achieving 98.20±0.15% even at an S: F ratio of 1:7. This shows that the PFOA extraction efficiency with TOPO: LauA is remarkably stable across a range of S: F ratios. This can be attributed to the high affinity between PFOA and TOPO: LauA, which ensures effective partitioning into the solvent phase even with minimal solvent quantities. This highlights TOPO: LauA as a cost-effective and environmentally sustainable extractant for PFOA from wastewater.

FIG. 7B illustrates the influence of mixing time and temperature on TOPO: LauA-PFOA extraction performance, according to some embodiments. Mixing time is also an important factor that directly influences the extraction efficiency of the liquid extraction processes, and the mixing time was varied from 1 minute to 2 h. Notably, the extraction efficiency, shown in FIG. 7B, remained relatively stable across the examined durations. As such, a brief mixing period of 1 min was sufficient to yield a consistent extraction efficiency of 99.52±0.04%. This can be attributed to the low viscosity of TOPO: LauA, which facilitates rapid mixing and mass transfer, coupled with its high selectivity and affinity towards PFOA, ensuring efficient extraction in a brief time frame, in contrast to adsorbents that require much longer time frames to reach equilibrium efficiency. Moreover, the effect of temperature on extraction was investigated over a temperature range of 15-100° C., as depicted in FIG. 7B. Remarkably, the results revealed a negligible temperature dependence of the extraction efficiency, which ranged from 99.63 to 99.76% across the studied temperatures. This sustained efficiency over a wide range of temperatures suggests the robustness of the TOPO: LauA system in maintaining high extraction performance under varying thermal conditions.

FIG. 7C illustrates the influence of initial feed concentration on TOPO: LauA-PFOA extraction, according to some embodiments. The concentrations were varied by four orders of magnitude (0.100 to 1000 ppm), representing a spectrum of conditions from low to high levels of PFOA contamination. TOPO: LauA maintained a remarkably consistent extraction efficiency ranging between 97.18 and 99.74%. The effectiveness of the DES across this broad range shows its significant commercial applicability, including environmental remediation of low-level contamination, as well as in the treatment of high-concentration industrial wastes. The minimal variation in the efficiency percentages also shows the stability and reliability of TOPO: LauA, making it a dependable choice for PFOA extraction.

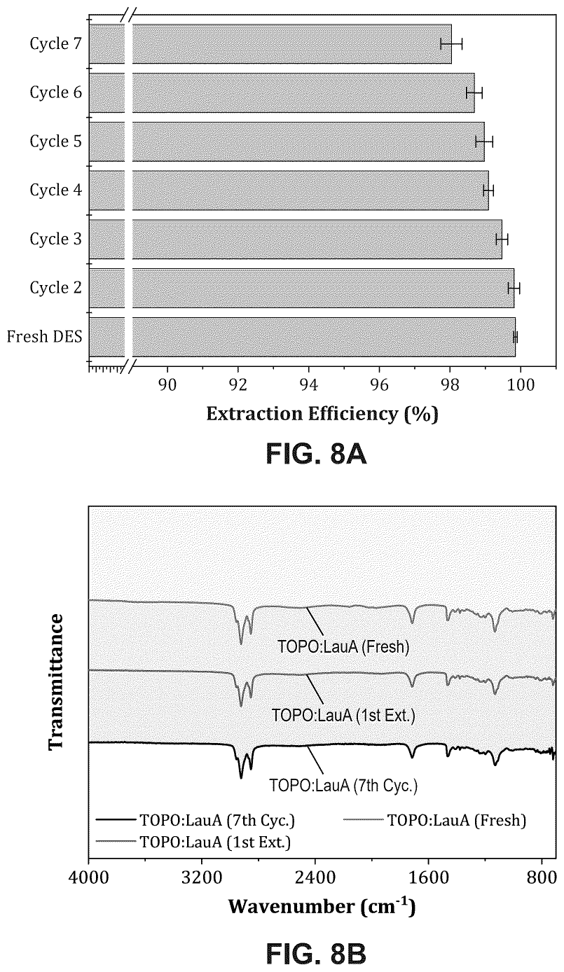

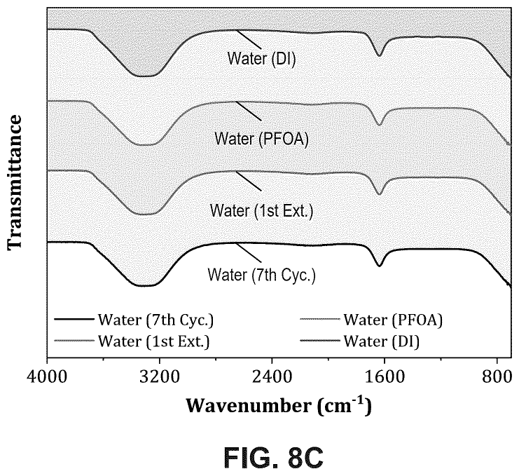

FIG. 8A illustrates multi-cycle performance of TOPO: LauA over seven consecutive cycles using fresh 1000 mg/L PFOA feed solution in each cycle, according to some embodiments. In liquid extraction, the concept of solvent capacity is important because it denotes the maximum amount of solute that a solvent can dissolve under specified conditions. This capacity significantly influences the efficiency of the process, where a solvent with a higher capacity requires less volume to extract a given amount of solute, making this process economically and environmentally advantageous. Utilizing a solvent with a greater capacity can streamline the extraction process by reducing the number of necessary extraction stages, which in turn lowers operational costs and diminishes the need for extensive equipment. Additionally, during the solvent recovery phase, a high-capacity solvent often results in more concentrated extract phases, potentially simplifying subsequent processing steps.

The reusability of TOPO: LauA was evaluated based on its effectiveness in removing PFOA across seven consecutive cycles, each utilizing a new 1000 mg/L PFOA feed solution. Remarkably, the extraction efficiency in FIG. 8A remained high throughout the cycles, ranging between 99.74% (1^{st} cycle) and 98.69% (7th cycle). The ability of TOPO: LauA to be reused multiple times without significant loss in efficiency is important. This underscores its applicability in sustainable extraction methods, reducing the need for producing new solvents and minimizing waste, which is especially important in large-scale applications where the cost of solvents and their environmental impacts are major considerations. Furthermore, the sustained high efficiencies across all cycles shows that TOPO: LauA effectively retained its essential properties for efficient PFOA extraction.

FIG. 8B illustrates FT-IR spectra of fresh TOPO: LauA and TOPO: LauA after the first and seventh cycles, according to some embodiments. FIG. 8C illustrates FT-IR spectra of 1000 mg/L PFOA feed water, DI water, and water after the first and seventh cycles, according to some embodiments. The FT-IR spectra exhibited no observable changes in TOPO: LauA after both cycles, showing that the extraction process did not significantly alter the chemical structure of the DES. Furthermore, the absence of discernible DES-related peaks in the water phase post-extraction indicates efficient separation of PFOA and a low tendency of the DES to leach into aqueous media. Furthermore, the consistent spectral profiles of the DES after the first and subsequent seven cycles demonstrated that TOPO: LauA maintained its physicochemical integrity throughout multiple extraction processes. Retention of these properties is important for effective PFOA extraction. The chemical stability of TOPO: LauA, along with its reusability, underscores its suitability as an eco-efficient and green solvent for sustainable PFOA extraction.

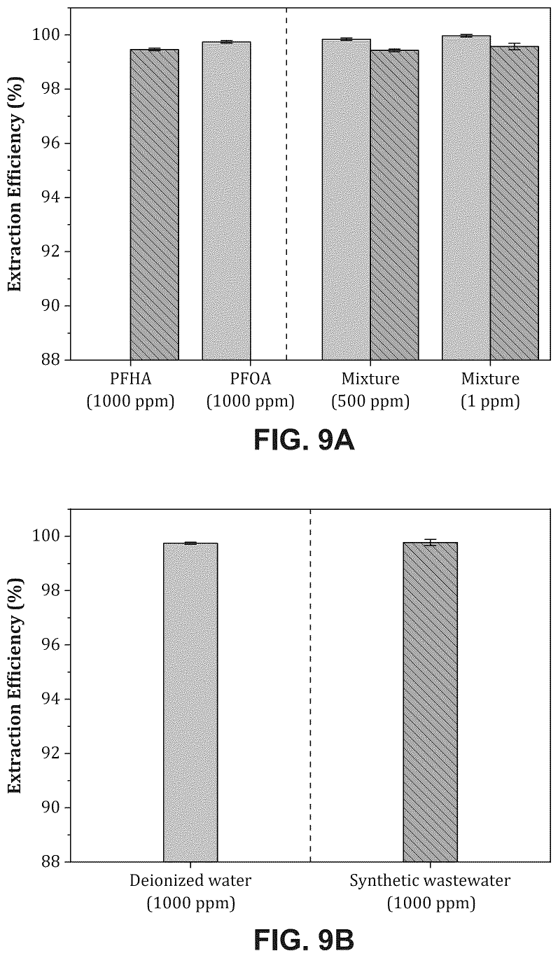

FIG. 9A illustrates extraction efficiencies of PFHA and PFOA in single-solute solutions at 1000 ppm and in mixtures at 500 ppm and 1 ppm, according to some embodiments. An extraction efficiency of 99.46% was achieved, which closely approached the 99.74% efficiency observed for PFOA under the same conditions. This performance is particularly noteworthy when compared with traditional adsorption processes, in which hydrophobic adsorbents typically display reduced adsorption capacities for shorter-chain PFASs such as PFHA, a consequence of weaker hydrophobic interactions than those involving PFOA. These results not only highlight the ability to selectively target and capture pollutants with similar structural characteristics but also illustrate the resilience of these materials to the shortcomings of other PFAS remediation strategies.

The selectivity and sensitivity of TOPO: LauA were investigated across diverse contamination contexts. In mixed-solute experiments targeting 500 ppm PFOA and PFHA, TOPO: LauA achieved remarkable removal efficiencies of >99% for both PFOA and PFHA. This observation is especially significant, as traditional adsorption processes often involve a significant decrease in removal efficiency due to competitive adsorption, where multiple contaminants compete for the limited active sites on the adsorbent surface. TOPO: LauA demonstrated superior performance in mixed solutions, even at low initial feed concentrations, achieving extraction efficiencies of >99% for both components at a concentration of 1 ppm.

FIG. 9B illustrates extraction efficiency of TOPO: LauA in DI water compared to that in synthetic wastewater, according to some embodiments. A synthetic wastewater matrix was also formulated by combining various compounds to simulate real wastewater compositions, encompassing a broad range of constituents such as organic matter, carbohydrates, fats, nitrogenous compounds, phosphorous and sulfur compounds, alkaline substances, trace elements, chlorides, and acids. Given the viability of wastewater composition from different sources, a wastewater composition was formed, as detailed in Table 4. Notably, even in the presence of other wastewater contaminants, TOPO: LauA effectively lowered the PFOA levels (initially at 1000 ppm) with an efficiency of 99.77±0.05%, which is identical to the extraction efficiency of TOPO: LauA for removing PFOA from DI water, as shown in FIG. 9B. The extraction time and efficiency remained unaffected by the presence of organic matter and other wastewater contaminants, in sharp contrast to membrane processes that often encounter flux reduction challenges owing to fouling by organic matter.

TABLE 4
Composition of the synthetic wastewater.

| Compound | Concentration (mg/L) |
|---|---|
| Sodium chloride | 200 |
| Ammonium chloride | 20 |
| Urea | 40 |
| Magnesium sulfate heptahydrate | 15 |
| Peptone | 4 |
| Glucose | 200 |
| Oleic acid | 105 |
| Anhydrous sodium sulfate | 20 |
| Potassium dihydrogen phosphate | 15 |
| Iron(III) chloride | 1 |
| Acetic acid | 10 |
| Perfluorooctanoic acid | 1000 |

Therefore, the DES (of the present disclosure) for PFAS removal offers significant advantages, providing high efficiency under different conditions and water types, effective reusability, minimal leachability and fast equilibration time, making it ideal for water treatment. In addition, the environmental sustainability of the solvent, which is derived from renewable sources such as coconut oil for lauric acid, combined with the use of TOPO as a liquefied extractant in a eutectic mixture, eliminates the need for harmful organic diluents.

TOPO: LauA clearly outperformed toluene (82.3%) with an extraction efficiency of 99.74% and also showed preferred properties in all other criteria. TOPO: LauA showed exceptional performance sustained under various operating conditions, with an efficiency of more than >98% at temperatures from 15 to 100° C., pH values from 3 to 9, PFOA initial concentrations varying by four orders of magnitude (0.100 to 1000 ppm), a fast equilibration time of only 1 min, and high efficiencies even at low solvent: feed volume ratios of 1:7 with minimal leachability into the aqueous phase (0.02 wt %). TOPO: LauA's stability and performance was confirmed over seven reusability cycles with no decrease in efficiency or degradation observed, as shown by spectroscopic analysis. Moreover, TOPO: LauA showed exceptional selectivity by maintaining >98% efficiency using other PFAS, in mixed PFAS environments, and in a synthetic wastewater environment, highlighting its practicality and economic feasibility for application in various commercial applications.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for liquid-liquid extraction, the method comprising:
contacting a first liquid with a second liquid sufficient to extract one or more per- and polyfluoroalkyl substances (PFASs) from the first liquid, wherein the second liquid includes a deep eutectic solvent.

2. The method of claim 1, wherein the first liquid includes water, and wherein the second liquid has a viscosity less than 120 mPa's at 25° C.

3. The method of claim 1, wherein the one or more PFASs includes perfluoroalkyl acids (PFAAs).

4. The method of claim 1, wherein the one or more PFASs includes at least one of a perfluorocarboxylic acid and a perfluoroalkylsulfonic acid.

5. The method of claim 1, wherein the one or more PFASs includes at least one of perfluorooctanoic acid, perfluorooctanesulfonic acid, perfluorohexanesulfonic acid, perfluorononanoic acid, and perfluoroheptanoic acid.

6. The method of claim 1, wherein a density difference between a first density of the first liquid and a second density of the second liquid is at least 0.1 g/mL.

7. The method of claim 1, wherein the deep eutectic solvent includes a hydrophobic deep eutectic solvent mixture including one or more compounds having a phosphine oxide group.

8. The method of claim 1, wherein the deep eutectic solvent includes trioctylphosphine oxide.

9. The method of claim 8, wherein the deep eutectic solvent further includes at least one of lauric acid and decanoic acid.

10. The method of claim 8, wherein the deep eutectic solvent further includes lauric acid, and wherein a molar ratio of trioctylphosphine oxide to lauric acid ranges from about 1:1 to about 1:3, and wherein a molar ratio of the second liquid to the first liquid ranges from about 1:1 to about 1:7.

11. The method of claim 1, wherein the deep eutectic solvent includes two or more of cineole, decanoic acid, thymol, lauric acid, menthol, trioctylphosphine oxide, tetraoctylammonium chloride, camphor, N,N,N′,N′-tetramethyl-p-phenylenediamine, and octanoic acid.

12. A method for liquid-liquid extraction, the method comprising:
introducing a first liquid into a liquid-liquid extraction unit, wherein the first liquid includes water and one or more per- and polyfluoroalkyl substances (PFASs); and
introducing a second liquid into the liquid-liquid extraction unit, wherein the second liquid includes a hydrophobic deep eutectic solvent having a viscosity less than 120 mPas at 25° C.

13. The method of claim 12, wherein the liquid-liquid extraction unit is capable of forming a raffinate product stream and an extract product stream.

14. The method of claim 13, wherein an initial concentration of PFASs in the first liquid is at least 90× greater than a concentration of PFASs in the raffinate product stream.

15. The method of claim 12, wherein a molar ratio of the second liquid to the first liquid introduced to the liquid-liquid extraction unit ranges from about 1:1 to about 1:7.

16. The method of claim 12, wherein the one or more PFASs includes at least one of perfluorooctanoic acid, perfluorooctanesulfonic acid, perfluorohexanesulfonic acid, perfluorononanoic acid, and perfluoroheptanoic acid.

17. The method of claim 12, wherein the liquid-liquid extraction unit includes a centrifugal extractor or a rotating disc extractor.

18. The method of claim 12, wherein the viscosity of the second liquid ranges from about 30 mPas to about 80 mPas at 25° C.

19. The method of claim 12, wherein the hydrophobic deep eutectic solvent includes trioctylphosphine oxide.

20. The method of claim 12, wherein the hydrophobic deep eutectic solvent includes at least one of decanoic acid and lauric acid.
